(19) United States
(12) Patent Application Publication
(10) Pub. No.: US 2018/0369954 A1
(43) Pub. Date: Dec. 27, 2018

(54) PISTON FOR INTERNAL COMBUSTION ENGINE AND METHOD OF MANUFACTURING PISTON FOR INTERNAL COMBUSTION ENGINE

(71) Applicant: HITACHI AUTOMOTIVE SYSTEMS, LTD., Ibaraki (JP)

(72) Inventors: Ittou SUGIMOTO, Tokyo (JP); Hirotsugu KAWANAKA, Tokyo (JP); Norikazu TAKAHASHI, Hitachinaka-shi (JP); Masato SASAKI, Hitachinaka-shi (JP)

(73) Assignee: HITACHI AUTOMOTIVE SYSTEMS, LTD., Ibaraki (JP)

(21) Appl. No.: 15/779,810

(22) PCT Filed: Nov. 29, 2016
(86) PCT No.: PCT/JP2016/085433

§ 371 Date: May 29, 2018

(30) Foreign Application Priority Data
Nov. 30, 2015 (JP) 2015-233208

(51) Int. Cl. B23K 20/12; B23K 20/24; F02F 3/00; F02F 3/10

(52) U.S. Cl. CPC B23K 20/122; B23K 20/24; B23K 2103/10; F02F 3/10; F02F 3/0084

(57) ABSTRACT

A piston for an internal combustion engine has a surface treatment portion on a piston base material at a piston crown surface, the surface treatment portion including, along the direction of depth from the surface side, a first layer that is comprised of a layer of a first metal or a layer containing the first metal, a second layer that contains both a second metal containing oxygen or an oxide of the second metal and a low-thermal-conductivity material, and a third layer that is comprised of a mixture of a third metal and the low-thermal-conductivity material.

### TECHNICAL FIELD

The present invention relates to a piston for an internal combustion engine and a method of manufacturing a piston for an internal combustion engine.

### BACKGROUND ART

Hitherto, there has been known a piston for an internal combustion engine in which a particular region that constitutes a part of a crown surface of the piston, that includes a fuel collision portion with which a fuel collides in a liquid state, and that includes a main combustion region is comprised of a member or structure having a low thermal conductivity and a low specific heat. According to this configuration, it is said that a temperature-raising effect at the fuel collision part can be enhanced, the combustion of the fuel colliding against the piston can be thereby promoted, deposition of the fuel on the piston crown surface can be reduced, and discharge of deposits and smoke can be restrained (Patent Document 1).

### PRIOR ART DOCUMENT

### Patent Document

Patent Document 1: JP-1999-193721-A

### SUMMARY OF INVENTION

### Problem to be Solved by the Invention

However, in the piston for an internal combustion engine disclosed in Patent Document 1, there is no description in regard of a specific method for configuring the member having the low thermal conductivity. In addition, there is a problem that the joining or adhesive strength at the interface between the low-thermal-conductivity member and the piston base material may be insufficient, due to a temperature distribution generated between the low-thermal-conductivity member and the piston base material.

### Means for Solving the Problem

In accordance with a first mode of the present invention, a piston for an internal combustion engine is provided with a surface treatment portion on a piston base material at a piston crown surface, the surface treatment portion including, along a direction of depth from a surface side, a first layer that is comprised of a layer of a first metal or a layer containing the first metal, a second layer that contains both a second metal containing oxygen or an oxide of the second metal and a low-thermal-conductivity material, and a third layer that is comprised of a mixture of a third metal and the low-thermal-conductivity material.

In accordance with a second mode of the present invention, a method of manufacturing a piston for an internal combustion engine is a method of manufacturing a piston for an internal combustion engine provided with a surface treatment portion at a crown surface, in which a step of forming the surface treatment portion includes, at least: a recess forming step of forming a recess in the crown surface of a piston base material of the piston; a first filling step of filling the recess with a first molding material which is a powder or a green compact of a powder; a first stir joining step of bringing a rotary tool into contact with the first molding material to soften the first molding material by frictional heat, thereby achieving solid-phase joining of the first molding material to the recess, and forming a stirred portion of the first molding material and the piston base material; a second filling step of filling a region over a formed layer formed by solid-phase joining in the first stir joining step with a second molding material which is a powder or a green compact of a powder; and a second stir joining step of bringing a rotary tool into contact with the second molding material to soften the second molding material by frictional heat, thereby achieving solid-phase joining of the second molding material to the recess, and forming a stirred portion of the second molding material and the piston base material.

### Effect of the Invention

According to the present invention, by providing the surface treatment portion configured as aforementioned, it is possible to provide a piston for an internal combustion engine in which discharge of deposits and smoke is restrained and a favorable fuel cost is obtained owing to excellent heat insulating characteristic. In addition, since the surface treatment portion and the piston base material are firmly joined to each other, it is possible to provide a piston for an internal combustion engine that is excellent in durability.

### BRIEF DESCRIPTION OF DRAWINGS

FIG. 1 is a conceptual diagram showing a sectional structure of a piston for an internal combustion engine according to one embodiment of the present invention.

FIG. 2 is a conceptual diagram showing a sectional structure of a piston for an internal combustion engine according to another embodiment of the present invention.

FIG. 3 shows views showing a sectional structure of a surface treatment portion according to one embodiment of the present invention, where FIG. 3(A) shows one in which all layers of the surface treatment portion are the same with one another in area, and FIG. 3(B) shows one in which the layers of the surface treatment portion are different from one another in area.

FIG. 4 is a view showing a sectional structure of a surface treatment portion according to one embodiment of the present invention.

FIG. 5 is a flow chart showing an example of a method of manufacturing a piston for an internal combustion engine according to one embodiment of the present invention.

FIG. 6 shows conceptual diagrams showing a procedure for forming a surface treatment portion by friction stir welding, in a method of manufacturing a piston for an internal combustion engine according to one embodiment of the present invention, where FIGS. 6(A) and 6(C) show filling with a material, FIGS. 6(B) and 6(D) show contact of a rotary tool, and FIG. 6(E) shows a surface treatment portion formed.

FIG. 7 is an image, picked up by an optical microscope, of a section of a surface treatment portion formed as Example 1-2.

FIG. 8 shows images, picked up by a scanning electron microscope, of a lowermost layer portion of the surface treatment portion formed as Example 1-2, where FIG. 8(B) is an image, picked up at a higher magnification, of the region surrounded by dotted line of FIG. 8(A).

FIG. 9 shows images, picked up by a scanning electron microscope, of a section of the surface treatment portion formed as Example 1-2, where FIG. 9(B) is an image picked up, at a higher magnification, of the region surrounded by dotted line of FIG. 9(A).

FIG. 10 is a graph showing the results of linear oxygen analysis along the direction of depth from the surface of the surface treatment portion formed as Example 1-2, by energy dispersion type X-ray spectroscopy.

FIG. 11 is a conceptual diagram showing a method of evaluating heat insulating characteristic of a surface treatment portion.

FIG. 12 shows conceptual diagrams showing the relation between an emission pattern of laser light and the surface temperature of a surface treatment portion, in evaluation of heat insulating characteristic, where FIG. 12(A) shows the emission pattern of the laser light emitted from a laser light source toward the surface treatment portion, and FIG. 12(B) shows the results of measurement of the surface temperature of the surface treatment portion by an infrared camera.

FIG. 13 shows views for explaining a layout relation between a joining jig used for forming a surface treatment portion and a piston, where FIG. 13(A) is a plan view of a piston crown surface as viewed from above, and FIG. 13(B) is a side view of FIG. 13(A).

FIG. 14 is a table showing combinations of a material of a powder 51, a material of a powder 52, and a material of a rotary tool, in Examples 1-1 to 1-8.

FIG. 15 is a table showing materials of a powder 51 and a powder 52 and the results of a tensile test of surface treatment portions formed using these materials, in Examples 1-9 to 1-17 and Comparative Examples 1-1 and 1-2.

FIG. 16 is a table showing peak temperatures T1 and T3 measured in evaluation of heat insulating characteristic, for specimens of Examples and Comparative Examples.

### MODES FOR CARRYING OUT THE INVENTION

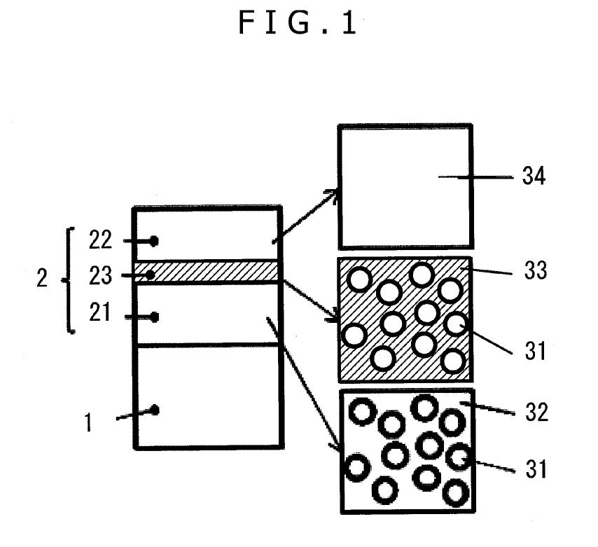

Embodiments of the present invention will be described below, referring to the drawings. FIG. 1 is a conceptual diagram showing a sectional structure of a piston for an internal combustion engine according to one embodiment of the present invention. As shown in FIG. 1, a surface treatment portion composed of a plurality of layers is configured at a crown surface of the piston for an internal combustion engine. The surface treatment portion has, along the direction of depth from the surface side, a layer 22 (hereinafter referred to as first layer) that is a layer of a first metal or contains the first metal, a layer 23 (hereinafter referred to as second layer) that is comprised of a mixture of both a second metal containing oxygen or an oxide of the second metal and a low-thermal-conductivity material, and a layer 21 (hereinafter referred to as third layer) that is comprised of a mixture of a third metal and the low-thermal-conductivity material.

A piston for an internal combustion engine is normally manufactured by processing a metal represented by an aluminum alloy. At a piston crown surface, for promoting combustion of a fuel, it is desired that a region concerning the combustion is sufficiently heat insulated to prevent temperature from being lowered at the time of combustion. In the case where a coating layer is formed on the piston crown surface by using only a low-thermal-conductivity material having a high heat insulating characteristic, however, there is a problem that adhesion or joining property between the low-thermal-conductivity material and the piston base material is insufficient, and it is impossible to secure a joining strength at the interface between both the materials.

In addition, for promoting combustion of the fuel in the vicinity of the piston crown surface, the region concerning the combustion should be uniformly raised in temperature. In the case where a coating layer is formed on the piston crown surface by using only a low-thermal-conductivity material having a high heat insulating characteristic, however, there is a problem that a region where temperature is locally raised tends to be generated on the surface of the coating layer.

In relation to this point, in the case where a single layer of a composite material of a metal and a low-thermal-conductivity material is formed on the piston crown surface, a sufficient joining strength can be obtained between the thus formed layer and the piston base material, and heat generated by combustion is conducted through the inside of the piston base material, so that the piston crown surface can be heated uniformly. However, there is a problem that the thermal conduction inside the piston base material is high, and, consequently, heat insulating characteristic becomes insufficient, so that the piston crown surface cannot be kept at a sufficiently high temperature.

In view of this, as shown in FIG. 1, a surface treatment portion having a first layer, a second layer and a third layer is formed on the piston crown surface, whereby the above-mentioned problem can be solved. The second layer is composed of a material that contains both a metal containing oxygen or an oxide of the metal and a low-thermal-conductivity material, thereby having a function of realizing a low thermal conductivity and restraining conduction of heat in the thickness direction of the surface treatment portion. In addition, the first layer at the surface of the surface treatment portion can be elevated in temperature with a uniform temperature distribution, since the underlying second layer has the heat conduction restraining function, and the first layer contributes to promotion of combustion of the fuel. Furthermore, the third layer has a function of obtaining a high joining strength between itself and the piston base material and, at the same time, restraining conduction of heat to the base material.

The metal used for the third layer is preferably any one of aluminum, magnesium, iron, copper, zinc, titanium, and nickel or an alloy containing at least one of these metals. These metals are metals that can undergo solid-phase joining to a metallic material used as the piston base material, whereby a high joining strength is easily obtained in relation to the piston base material.

As above-mentioned, the piston base material is ordinarily an aluminum alloy, and, therefore, the metal used for the third layer making contact with the piston base material is preferably aluminum or an aluminum alloy. Aluminum or an aluminum alloy can obtain a high joining strength in relation to the aluminum alloy by a solid-phase joining method. Besides, the metal used for the first layer is also preferably aluminum or an aluminum alloy. As a result of this, the first layer and the third layer ensure that joining to the piston base material, which is an aluminum alloy, with a high adhesive strength can be obtained by a solid-phase joining method, and a uniform heating condition can be easily obtained at a surface layer of the surface treatment portion.

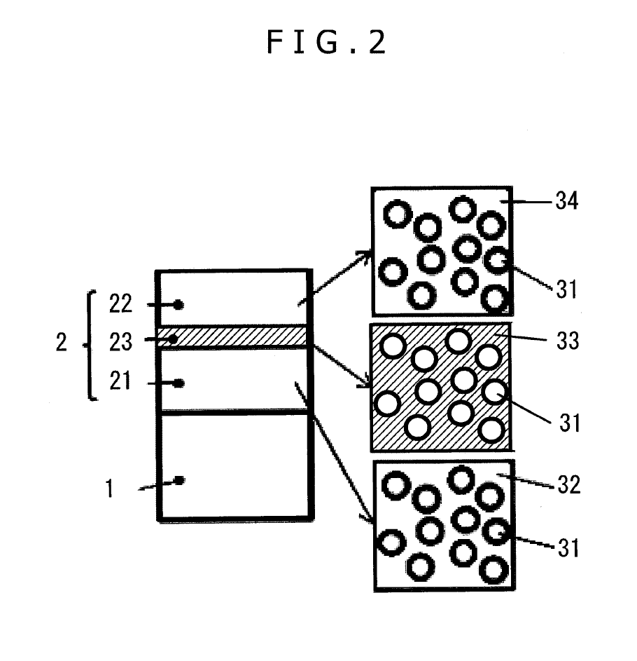

FIG. 2 is a conceptual diagram showing a sectional structure of a piston for an internal combustion engine according to another embodiment of the present invention. As illustrated in FIG. 2, at the crown surface of this piston for an internal combustion engine, also, a surface treatment portion composed of a plurality of layers is configured. In the present embodiment, a first layer is a layer comprised of a mixture of a metal and a low-thermal-conductivity material. By such a configuration, heat insulating characteristic of the surface treatment portion can be further enhanced.

A metal contained in the state of containing oxygen or in the state of an oxide, of a second layer, is preferably the same as a metal contained in a third layer. In the piston for an internal combustion engine according to the embodiment of the present invention, a configuration may be adopted where the crown surface is shaped to have a recess, and a surface treatment portion is provided in the structure of filling the recessed surface.

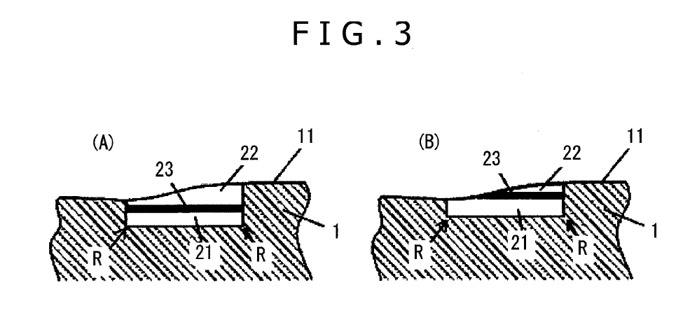

FIG. 3 shows views showing a sectional structure of a surface treatment portion formed on a recessed surface provided in a piston crown surface 11 described above. FIG. 3(A) shows a case where all the plurality of layers constituting the surface treatment portion are formed to be the same in area. In addition, FIG. 3(B) shows a case where a first layer and a second layer of the plurality of layers constituting the surface treatment portion are partly lacking. In other words, the layers of the surface treatment portion are different from one another in area. In either of the cases of FIG. 3(A) and FIG. 3(B), a piston for an internal combustion engine that has a favorable fuel cost and excellent durability is provided. Note that while the first layer and the second layer are not formed over the whole region of the surface treatment portion in the configuration shown in FIG. 3(B) as above-mentioned, a piston for an internal combustion engine that has a favorable fuel cost and excellent durability can be provided if the second layer is formed over equal to or more than 50% of the surface area of the surface treatment portion.

In the piston for an internal combustion engine in each of the above embodiments, a connection portion where a side surface and a bottom surface contact each other, in the recess formed in the piston crown surface 11 for forming the surface treatment portion, is preferably comprised of a curved surface. With such a curved surface configured, favorable solid-phase joining of a molding material can be achieved over the whole region of the recess. In the case where this portion is not a curved surface, the molding material would be left at the connection portion in the state of not having undergone solid-phase adhesion, thereby causing generation of a portion of inadequate solid-phase joining.

The second layer is preferably thicker at a peripheral portion than at a central portion. At a peripheral portion of a piston, conduction of heat to a piston side surface is generated. With the second layer formed to be thicker at a peripheral portion than at a central portion, conduction of heat to the piston side surface can be restrained, and a heat insulating effect can be enhanced. In addition, a structure having a stirred portion is preferably provided at an outer peripheral portion of the surface treatment portion. The stirred portion refers to a portion where a flow of composition of material has occurred. An outer peripheral portion of the surface treatment portion has a tendency that it is difficult to secure a joining strength, but, when a region where the material of the piston base material and the material of the surface treatment portion have been stirred is provided, the joining strength can be secured thereby.

While a sufficient heat insulating effect can be obtained even where the second layer is a single layer, a higher heat insulating effect can be expected favorably in a configuration in which a plurality of the second layers are provided. The area of the surface treatment portion is preferably smaller on a lower portion side (lower portion side) than on the piston crown surface side (upper portion side).

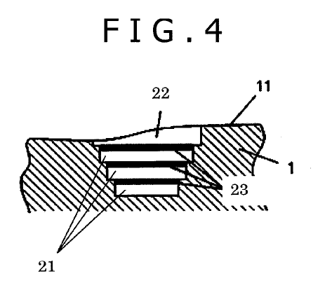

FIG. 4 shows a sectional structure of a surface treatment portion where a second layer and a third layer are provided alternately and repeatedly three times beneath a first layer. As illustrated in FIG. 4, the areas of the layers are so set that an upper layer is larger than a lower layer in area. An advantage of such a configuration is as follows. It is preferable that the heat insulating effect is higher at an upper portion of the surface treatment portion, but, on the other hand, the heat transferred without being shielded at an upper portion of the surface treatment portion should be released at a lower portion of the surface treatment portion. In this regard, the area of the layer at the lower portion of the surface treatment portion is set to be smaller, whereby a migration path for the heat transferred without being shielded can be secured.

The position where the surface treatment portion is formed is not particularly limited, but the position is preferably at the piston crown surface in the vicinity of a region where the fuel is injected. In the region where the fuel is injected, the liquid fuel is evaporated and combusted, and, therefore, by forming the surface treatment portion at this position, it is possible to enhance a combustion promoting effect.

The low-thermal-conductivity material is not particularly restricted, but it is preferable to use any one, or a plurality in combination, of zirconia, cordierite, mullite, silicon, silica, mica, talc, silicate glass, acrylic glass, organic glass, silica aerogel, hollow ceramic beads, hollow glass beads, hollow metal balls, organosilicon compound, and ceramic fiber.

In the second layer and the third layer, the volume ratio of the low-thermal-conductivity material contained therein is preferably equal to or more than 45%. In the case where the volume ratio of the low-thermal-conductivity material is equal to or more than 45%, a high heat insulating characteristic can be obtained, and, therefore, the piston crown surface can be raised in temperature in a shorter time, whereby a higher combustion promoting effect can be expected.

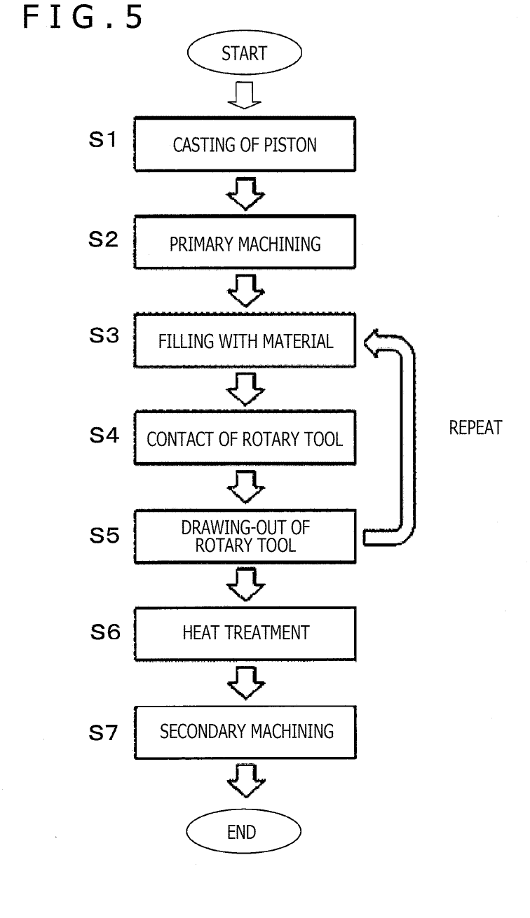

FIG. 5 is a flow chart showing an example of a method of manufacturing a piston for an internal combustion engine according to one embodiment of the present invention. In step S1, casting of a piston is conducted. In the piston casting, a crude material of a piston made of an aluminum alloy is cast by a known method such as a die casting method. In the subsequent step S2, primary machining is conducted, in which the crude material of the piston is subjected to predetermined machining which includes cutting of an outside diameter of a land portion and machining of a pin hole. A recess for forming a surface treatment portion at the piston crown surface may be formed by casting-out at the time of piston casting in step S1, or may be formed by machining at the time of primary machining in step S2.

In step S3, the recess formed in the piston crown surface is filled with a material for forming the surface treatment portion. In this case, the material may be used for filling in the state of a powder, or a pressure may be exerted on the powder to produce a green compact (briquet) and the green compact may be used for filling.

Next, in step S4, in a state in which a rotary tool is put in contact with the material filling the recess, the rotary tool is rotated for a predetermined time. Subsequently, in step S5, the rotary tool is drawn out of the recess. By the series of steps from step S3 to step S5, friction stir welding (FSW: Friction-Stir-Welding) is performed. The steps from step S3 to step S5 are repeated a number of times according to the number of layers required. The friction stir welding will be described in detail later.

In step S6, the piston formed with the surface treatment portion is taken out, and subjected to a heat treatment. This heat treatment is for the purpose of removing strains generated attendant on plastic flow of the material during the friction stir welding and making the surface treatment portion uniform in strength. Examples of the heat treatment include a solution aging treatment and an artificial aging treatment. After the heat treatment is conducted in step S6, secondary machining is performed in step S7. As the secondary machining, finishing cutting is conducted, whereby a piston as a product is completed.

Steps S3 to S5 will be described in detail. In step S3, first, the recess in the piston crown surface is filled with the material for forming the third layer of the surface treatment portion. Next, the rotary tool is rotated as above-mentioned in step S4, after which the rotary tool is drawn out of the recess in step S5. By this, the third layer is formed. In this instance, a surface layer of the third layer becomes the second layer. Next, returning to step S3, a region over the second layer is filled with the material for forming the first layer. Subsequently, the rotary tool is rotated in step S4, after which the rotary tool is drawn out of the recess in step S5. By this, the first layer is formed on the second layer. Note that the process of formation of the second layer will be described in detail later.

As above-mentioned, the steps S3 to S5 are repeated as required according to the configuration of the surface treatment portion to be formed. For example, in the case of a configuration in which the third layer and the second layer are alternately repeated as shown in FIG. 4, the steps S3 to S5 are repeated a number of times according to the repetition number, to form the third layers. By this, a configuration in which the third layer and the second layer are alternately repeated is obtained. After the required repetition numbers of the third layers and the second layers are formed, the first layer is formed on the second layer formed finally, by steps S3 to S5.

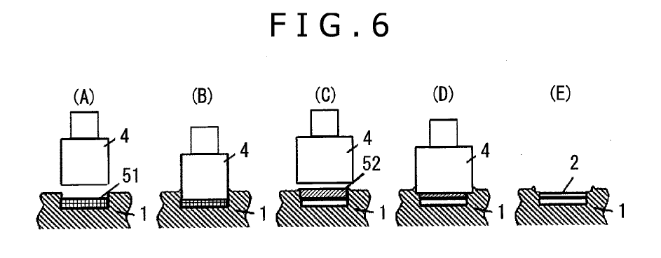

FIG. 6 shows conceptual diagrams showing an example of the procedure of friction stir welding for forming the surface treatment portion at the piston crown surface. FIG. 6(A) shows a state in which a recess formed in a piston crown surface has been subjected to first-time filling with a material (filling with a powder 51). Specifically, FIG. 6(A) shows a state in which the recess has been filled with a material (a powder or a green compact of a powder) for forming the third layer.

FIG. 6(B) shows a state in which a rotary tool 4 is inserted into the recess and is being rotated in the state of making contact with the material filling the recess. By this, the material for forming the third layer is softened by frictional heat, and is joined to a bottom portion and a side portion of the recess by friction stir welding. In other words, first-time friction stir welding is performed. In this instance, the second layer is formed simultaneously, as above-mentioned.

FIG. 6(C) shows a state in which second-time filling with a material (filling with a powder 52) has been conducted. Specifically, FIG. 6(C) shows a state in which a region over the second layer formed in the recess is filled with a material (a powder or a green compact of a powder) for forming the first layer. FIG. 6(D) shows a state in which the rotary tool 4 is inserted into the recess and is being rotated in the state of making contact with the material placed for filling. By this, the material for forming the first layer is softened by frictional head, and is joined to the previously formed second layer and the side portion of the recess by friction stir welding. In other words, second-time friction stir welding is performed. FIG. 6(E) shows a state in which a surface treatment portion has been formed in the recess in the piston crown surface by the series of steps.

In the next place, the friction stir welding will be described. The friction stir welding is one of solid-phase joining techniques for joining a metal and a metal to each other. In order to perform the friction stir welding, a rotary tool is rotated in the state of being pressed against a metallic material to be joined, to heat the metallic material by frictional heat generated, and to cause a flow of composition in the metallic material (or to stir the metallic material), thereby joining the metallic material.

As another method for joining metallic materials, there are also fusion welding methods such as arc welding. In the fusion welding method, however, the metallic material undergoes a process of melting followed by solidification, so that a structure attendant on the solidification is formed in the weld joint, which would cause deterioration of strength characteristic or the like. On the other hand, in the friction stir welding, melting (fusion) and solidification of the material do not occur, so that the strength problem as above-mentioned is not generated, and the material can be joined more firmly. The surface treatment portion according to the present invention is preferably formed by friction stir welding.

In addition, according to friction stir welding, in an oxygen-containing environment such as in the air, a metallic material can be joined with little adverse influence exerted on joining strength by oxidation of the material. According to the friction stir welding, not only metallic materials but also other metal-containing materials can be joined without generation of defective bonding attendant on oxidation of the material at the joint portion.

In friction stir welding, when the rotary tool is rotated in contact with the material to be joined, a state in which oxygen is liable to be bonded to the metal contained in the material is generated at the surface of the material with which the rotary tool is in contact. For this reason, a surface layer portion of the joined layer is a layer of another composition that contains either a metal containing oxygen or an oxide of the metal.

Specifically, at the time of forming the third layer by the first-time friction stir welding step, the surface layer portion of the third layer becomes a layer of a mixture of a metal containing oxygen or an oxide of the metal with the low-thermal-conductivity material. In other words, the second layer can be formed simultaneously. Thereafter, the first layer can be formed by second-time friction stir welding.

Therefore, a region containing much oxygen may be formed also at a surface layer portion of the first layer of the surface treatment portion. In the case where such a region has been formed, it can be removed by cutting, which is shown as a secondary machining step. Note that where the friction stir welding step for the outermost surface layer (first layer) is conducted in a non-oxygen-containing atmosphere such as argon gas or vacuum, formation of an oxygen-containing region can be restrained thereby.

In the first-time material filling step, a mixed powder containing the metal and the low-thermal-conductivity material or a green compact of the mixed powder is used. By this, the third layer in which the low-thermal-conductivity material is dispersed can be formed, as shown in FIGS. 1 and 2.

In the fusion welding method such as arc welding, there is a problem that when it is intended to form the surface treatment portion by use of a mixed powder or a green compact thereof, the metal and the low-thermal-conductivity material would separate from each other, since they are different in melting point and specific gravity. In this point, also, the formation of the surface treatment portion by friction stir welding which has a mechanical stirring action makes it possible to form a layer in which the metal and the low-thermal-conductivity material are dispersed uniformly throughout the layer.

In the case where the friction stir welding is conducted using a material obtained by mixing a metallic powder with a low-thermal-conductivity material powder, only the metallic powder is joined to the piston base material, whereby the layer formed is fixed to the piston base material. In other words, the low-thermal-conductivity material and the piston base material are not joined directly to each other. In determining the content ratio of the low-thermal-conductivity material, therefore, attention should be paid to the joining strength. According to the present inventors' research, it is preferable that the volume ratio of the low-thermal-conductivity material in the mixed powder is equal to or less than 80%. Where the volume ratio exceeds 80%, the joining strength may be insufficient, and the surface treatment portion once formed may peel off.

### Example 1

A specimen deemed as a piston crown surface is produced, and a surface treatment portion is formed at a surface of the specimen. A disk-shaped specimen was produced from an aluminum alloy (4032-T6) similar to the material of a piston base material, and a recess measuring 30 mm in diameter and 5 mm in depth was formed in an upper surface of the specimen. After the recess was filled with a predetermined amount of a powder 51, a load was applied while rotating a rotary tool with a diameter of 30 mm at 800 rpm, to press the powder 51 into the recess of the specimen. The rotary tool was held for a predetermined time in such a state that the lower end of the rotary tool was positioned at a height of 1.5 mm from the lower surface of the recess, after which the rotary tool was drawn out of the recess.

Next, the recess was filled with a predetermined amount of a powder 52, and a load was applied while rotating a rotary tool with a diameter of 34 mm at 800 rpm. By this, the powder 52 was pressed in by the rotary tool while crushing the periphery of the recess of the specimen. The rotary tool was held for a predetermined time in such a state that the tip of the rotary tool was positioned at a height of 3.0 mm from the bottom surface of the recess, after which the rotary tool was drawn up, to finish the friction stir welding.

By the above-mentioned procedure, the surface treatment portion of about 3.0 mm in thickness was formed in the recess of the specimen. Next, a surface layer of the surface treatment portion was removed by 0.1 mm by turning process, thereby planarizing the upper surface of the disk-shaped specimen. Note that while burs of the specimen base material were formed in the periphery of the recess due to the pressing-in of the rotary tool, the burs were removed by the turning process.

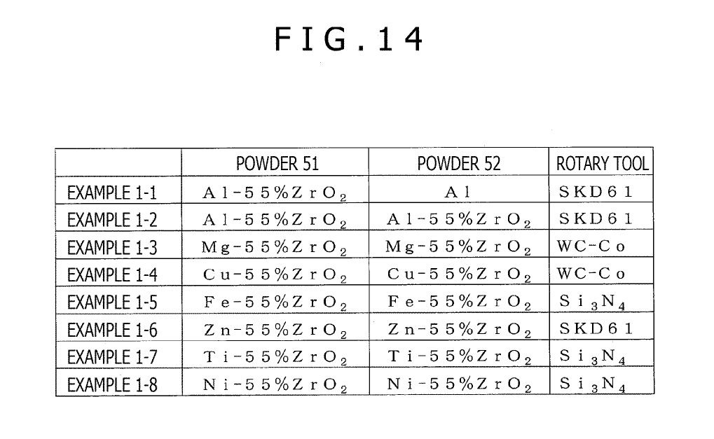

By variously changing the materials of the powder 51 and the powder 52, a plurality of kinds of surface treatment portions were formed in the recesses of the specimens, as Examples 1-1 to 1-8. The materials of the powder 51 and the powder 52 and the materials of the rotary tool in Examples 1-1 to 1-8 are as set forth in FIG. 14. Note that the powder 51 is the powder material used for filling in the first-time material filling step, and the powder 52 is the powder material used for filling in the second-time material filling step.

As the metallic powder, a powder produced by an atomizing method was used. In FIG. 14, Al represents a pure aluminum powder with an average particle diameter of 30 μm, Mg a pure magnesium powder with an average particle diameter of 30 μm, Cu a pure copper powder with an average particle diameter of 30 μm, Zn a pure zinc powder with an average particle diameter of 50 μm, Fe a pure iron powder with an average particle diameter of 50 μm, Ti a pure titanium powder with an average particle diameter of 30 μm, and Ni represents a pure nickel powder with an average particle diameter of 30 μm. In addition, as a low-thermal-conductivity material, ZrO₂ represents a yttria-stabilized zirconia powder formed into a spherical shape with an average particle diameter of 30 μm. Note that the value of percentage shown in FIG. 14 represents the volume ratio of the low-thermal-conductivity material based on the whole part of the powder material.

The material of the rotary tool to be used in the friction stir welding method is preferably selected according to the kind of the metallic material contained in the material to be joined. In the case where the metallic material is Al or Zn which has a comparatively low melting point, a rotary tool formed from tool steel SKD61 can be used.

In the case where the metallic material is Mg which has high reactivity or Cu which has an intermediate melting point, it is preferable to use a rotary tool formed from a hard metal composed of a WC—Co alloy (a mixed sintered material of tungsten carbide with cobalt). Besides, in the case where the metallic material is Fe, Ti or Ni which has a high melting point, it is preferable to use a rotary tool formed from silicon nitride.

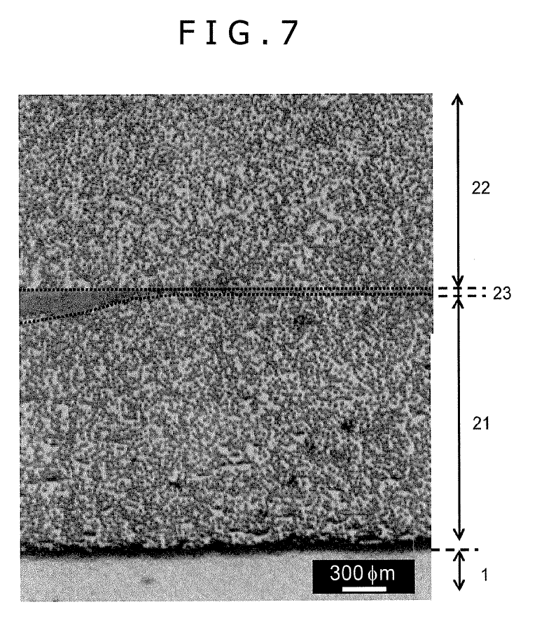

FIG. 7 is an image of a section of a surface treatment portion of Example 1-2, picked up by an optical microscope. In FIG. 7, the left side is a side near a side surface of the piston, and the right side is a side near a central portion of the piston. It is seen that the surface treatment portion includes a third layer 21 and a first layer 22, with a second layer 23 formed between these layers. In addition, it is seen that zirconia as a low-thermal-conductivity material 31 is uniformly dispersed, the third layer and the first layer.

Besides, as seen from FIG. 7, the thickness of the second layer 23 is greater on the left side near the piston central portion than on the right side of the piston central portion side. The reason for this lies in that when the friction stir welding is conducted, the circumferential speed is higher on the outer side than on the inner side of the rotary tool, so that more frictional heat is generated, the temperature is liable to be higher, the amount of oxygen taken in is larger, and hence the second layer is formed to be thicker, on the outer side of the rotary tool.

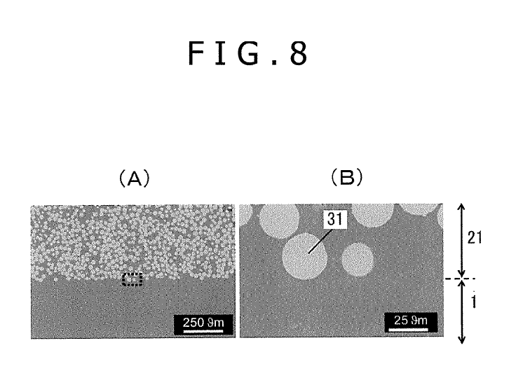

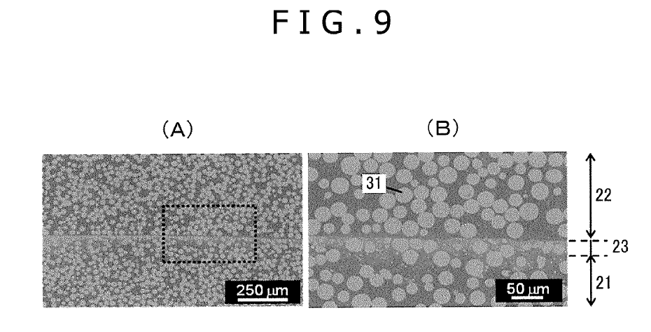

FIGS. 8 and 9 show images of the section of the surface treatment portion of Example 1-2 shown in FIG. 7, picked up by a scanning electron microscope. FIG. 8 shows enlarged images of an interface between a piston base material 1 and the third layer 21 as a lowermost layer of the surface treatment portion, where FIG. 8(B) is an image, picked up at a higher magnification, of the region surrounded by dotted line of FIG. 8(A). In addition, FIG. 9 shows enlarged images of the first layer, the second layer and the third layer, with the second layer 23 sandwiched. FIG. 9(B) is an enlarged image of the region surrounded by dotted line of FIG. 9(A).

As seen from FIG. 8, the aluminum alloy as the material of the piston base material 1 and aluminum of the third layer as the lowermost layer of the surface treatment portion are bonded perfectly to each other, and the interface between them is unclear. In other words, it is seen that in this structure, the metallic material of the surface treatment portion is united with the piston base material.

Where the metallic powder contained in the powder 51 used as the first-time filling material is aluminum, as in Examples 1-1 and 1-2, the layer formed is joined to the aluminum alloy-made piston base material with a high adhesive strength. However, even where the metallic powder contained in the powder 51 is other metal than aluminum, the layer formed is joined to the aluminum alloy-made piston base material with a sufficient adhesive strength, so long as the metal is a material capable of alloying with aluminum or forming an intermetallic compound with aluminum. For example, magnesium, copper, iron, zinc, titanium, nickel and the like can be used, as in Examples 1-3 to 1-8.

In addition, as seen from FIG. 9, it can be confirmed that the second layer is formed between the third layer formed by the first-time friction stir welding and the first layer formed by the second-time friction stir welding.

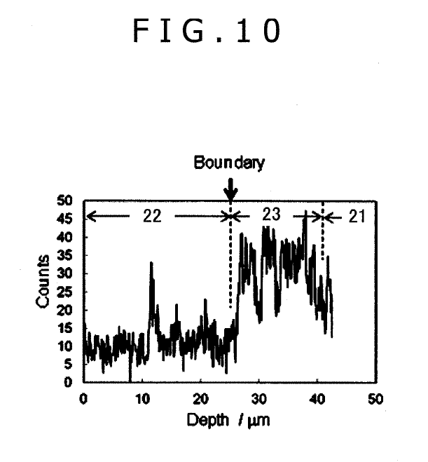

FIG. 10 is a graph showing the results of linear oxygen analysis along the direction of depth from the surface of the surface treatment portion formed as Example 1-2, by energy dispersion type X-ray spectroscopy. It is seen that oxygen concentration is high in a region deeper than about 26 μm from the surface of the surface treatment portion. This region corresponds to the second layer, and, accordingly, it is seen that much oxygen is contained in the second layer.

Besides, in the case where the metallic material contained in the powder 51 used in the first-time friction stir welding and the metallic material contained in the powder 52 used in the second-time friction stir welding are of the same kind, a higher adhesion can be obtained at the interface between the first layer and the second layer and at the interface between the second layer and the third layer. While the second layer containing oxygen is formed between the first layer and the third layer, if the metallic materials contained in the first layer and the third layer are of the same kind, a more firmly joined state can be obtained owing to similarity in crystal structure.

In order to confirm the adhesive strength of the surface treatment portion, a tensile adhesion test as specified in JIS-H8402 was conducted. From a specimen, a cylindrical portion with a diameter of 25 mm including the surface treatment portion formed at the surface of the specimen is cut out. Two cylindrical jigs with a diameter of 25 mm are prepared. The two jigs are adhered respectively to an upper surface and a lower surface of the specimen formed with the surface treatment portion, by an epoxy adhesive.

The two cylindrical jigs were pulled by a tensile tester, a tensile stress in a direction perpendicular to the surface treatment portion was thereby generated in the surface treatment portion, and the stress at the time when the surface treatment film was ruptured or peeled off the specimen base material was measured. This stress was evaluated as the adhesive strength of the surface treatment portion. Note that since the breaking strength of the epoxy adhesive is 80 MPa, the epoxy adhesive portion is ruptured in the case where the adhesive strength of the surface treatment portion is equal to or more than 80 MPa. In such a case, the true adhesive strength of the surface treatment portion is not measured, and, therefore, the adhesive strength was evaluated as equal to or more than 80 MPa. When evaluation was conducted for Examples 1-1 to 1-8, the epoxy resin portion was ruptured in all cases. In other words, the adhesive strength was equal to or more than 80 MPa.

Next, by use of the powders 51 and 52 in which the kind of the low-thermal-conductivity material and its content were changed, surface treatment portions were formed on specimens by friction stir welding, to obtain specimens as Examples 1-9 to 1-17. These specimens were also put to evaluation of adhesive strength by the same procedure as above-described for Examples 1-1 to 1-8. Note that in each of these Examples, the same material was used as the powders 51 and 52.

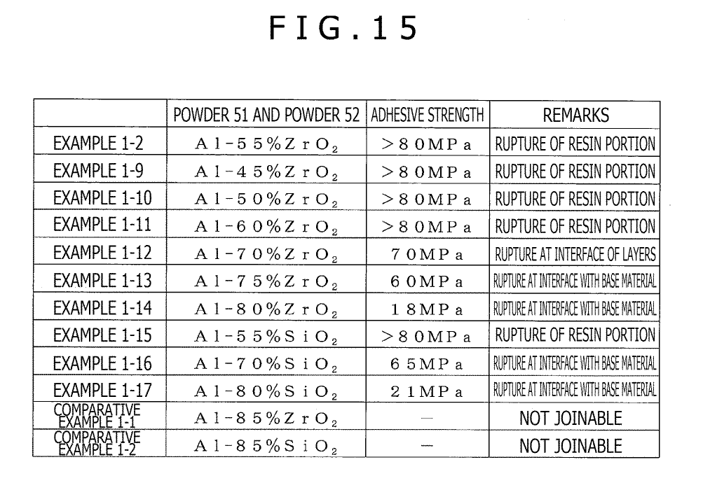

In addition, as comparative examples, Comparative Example 1-1 in which a surface treatment portion was formed using a mixed powder of aluminum and zirconia with a zirconia content in terms of volume ratio of 85% as the powders 51 and 52 and Comparative Example 1-2 in which a surface treatment portion was formed using a mixed powder of aluminum and silica with a silica content in terms of volume ratio of 85% as the powders 51 and 52 were also put to evaluation. The powders 51 and 52 used in production of specimens in Examples 1-9 to 1-17 and Comparative Examples 1-1 and 1-2 and the results of tensile test on the surface treatment portions formed using these materials are set forth in FIG. 15.

FIG. 15 shows evaluation results of adhesive strength of the surface treatment portions of Examples 1-9 to 1-17 and Comparative Examples 1-1 and 1-2 (for reference, the result of Example 1-2 is also shown). As seen from FIG. 15, a predetermined adhesive strength can be obtained when the low-thermal-conductivity material is contained in a volume ratio of up to 80%. It has been found, however, that in the case where the low-thermal-conductivity material is contained in a volume ratio of 85%, the surface treatment portion is not fixed by friction stir welding, and the powder falls off.

In the case where the content of the low-thermal-conductivity material in terms of volume ratio was equal to or less than 60%, the epoxy adhesive portion was ruptured, and the adhesive strength was equal to or more than 80 MPa. In the case where the content of the low-thermal-conductivity material in terms of volume ratio was 70%, rupture in the inside of the surface treatment portion (at interface between layers) occurred in Example 1-12 in which the low-thermal-conductivity material was zirconia, whereas the surface treatment portion was ruptured at the interface with the specimen base material occurred in Example 1-16 in which the low-thermal-conductivity material was silica. The adhesive strengths in these Examples were 70 MPa and 65 MPa, respectively. In the case where the content of the low-thermal-conductivity material in terms of volume ratio was 75% (Example 1-13: the low-thermal-conductivity material was zirconia), the adhesive strength was equal to or more than 60 MPa.

In the cases where the content of the low-thermal-conductivity material in terms of volume ratio was 80%, the surface treatment portion was ruptured at the interface with the specimen base material. In Example 1-14 in which the low-thermal-conductivity material was zirconia, the adhesive strength was 18 MPa. Besides, in Example 1-17 in which the low-thermal-conductivity material was silica, the adhesive strength was 21 MPa. In other words, a predetermined adhesive strength was shown in both of these Examples. Note that in the cases where the content of the low-thermal-conductivity material in terms of volume ratio is up to 75%, a high adhesive strength can be obtained, which is more favorable.

### Example 2

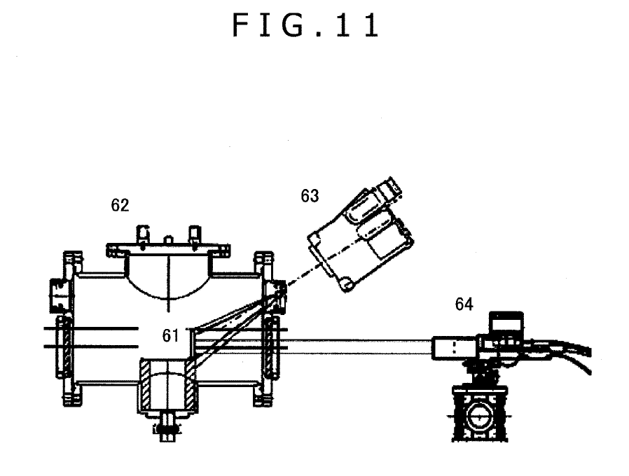

Heat insulating characteristic of the surface treatment portion was evaluated. A specific evaluation method will be described referring to FIG. 11. FIG. 11 is a conceptual diagram showing the evaluation method. A specimen 61 of each of Examples and Comparative Examples which has been formed with the surface treatment portion is disposed inside a vacuum chamber 62, laser light is emitted from a laser light source 64, and surface portions of the specimen 61 are irradiated with the laser light. In this state, variation in the surface temperature of the specimen is measured by an infrared camera 63.

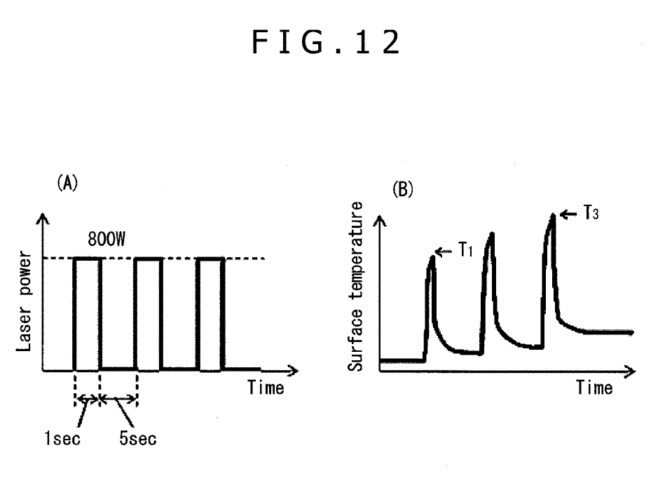

FIG. 12 shows conceptual diagrams showing the relation between an emission pattern of laser light and the surface temperature of the surface treatment portion FIG. 12(A) shows the emission pattern of the laser light emitted from the laser light source 64 toward the surface treatment portion, and FIG. 12(B) shows the results of measurement of time variation in the surface temperature of the surface treatment portion by the infrared camera 63. A peak temperature measured upon first-time irradiation with laser is referred to as T1, and a peak temperature measured upon third-time irradiation with laser is referred to as T3.

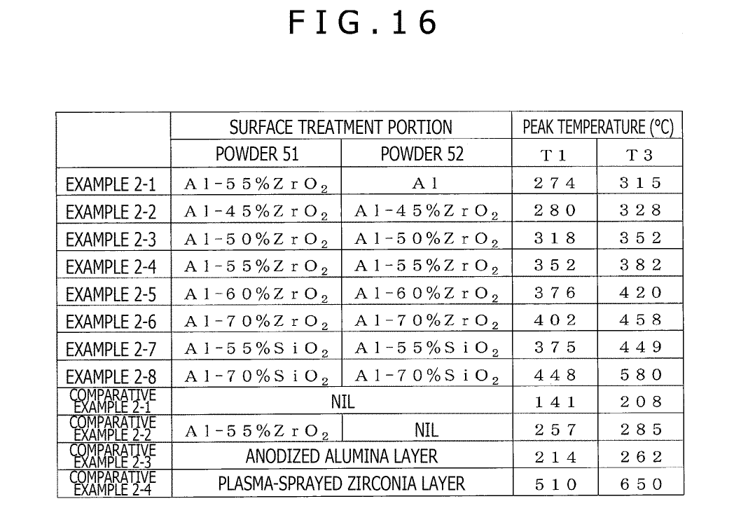

For specimens of Examples and Comparative Examples, the measured values of the peak temperatures T1 and T3 are set forth in the table of FIG. 16. In FIG. 16, Examples 2-1 to 2-8 are examples in which the specimen was formed with the surface treatment portion by friction stir welding. Note that the surfaces of all the specimens were coated with a black body coating material.

Comparative Example 2-1 is a specimen not having undergone a surface treatment. Comparative Example 2-2 is a specimen in which a single layer of Al-55% ZrO₂ with a thickness of 2.9 mm was formed, not by friction stir welding. Comparative Example 2-3 is a specimen in which an alumina layer with a thickness of 20 μm was provided on a surface of the specimen by anodizing. Comparative Example 2-4 is a specimen in which a zirconia layer with a thickness of 1.5 mm was provided on a surface of the specimen by plasma spraying. Note that as every one of the materials of the specimens in these Examples and Comparative Examples, an aluminum alloy (4032-T6) similar to the piston base material was used.

For evaluation of heat insulating characteristic, it is necessary to take a combustion reaction in the internal combustion engine into consideration. This point will be described below. For promoting the combustion reaction in the internal combustion engine, it is important to elevate the surface temperature of the piston crown surface. For example, the autoignition points of light oil and heavy oil are 250° C. to 350° C., and the temperature at the time of ignition of gasoline is about 300° C. For promoting the combustion of these fuels, therefore, it is necessary to raise the surface temperature of the piston crown surface to around 300° C.

In evaluation of heat insulating characteristic in the present embodiment, for realizing an environment inside the combustion chamber of an internal combustion engine on a simulation basis, emission conditions of laser light from the laser light source 64 were so set that the peak temperature upon irradiation of the specimen of Comparative Example 2-1 with the laser light would be about 200° C. Specifically, as shown in FIG. 12(A), the specimen of Comparative Example 2-1 was irradiated with laser light in a total of three sets, each set consisting of an irradiation pattern of irradiating with laser light of 800 W in intensity for one second, followed by stopping the irradiation for five seconds.

The surface temperature of the specimen rises during when the specimen is irradiated with the laser light, but, when the irradiation with the laser light is stopped, the surface temperature is lowered through natural heat radiation. FIG. 12(B) shows such a temperature variation with lapse of time.

A plurality of specimens are irradiated with the laser light from the laser light source 64 as above-mentioned, the temperature variations are measured, and those specimens the surface temperatures of which can be raised to or above 300° C. are evaluated to have an excellent temperature-raising effect.

As seen from FIG. 16, the specimen of Comparative Example 2-2 showed T3 being raised to 285° C., so a certain extent of heat insulating effect can be recognized, but it is insufficient. This is considered to be because this specimen was not formed with a layer corresponding to the second layer. In addition, a sufficient heat insulating effect was not obtained with the specimen of Comparative Example 2-3. In other words, the heat insulating effect of an alumina layer is insufficient.

On the other hand, the specimens of Examples 2-1 to 2-8 all showed T3 of equal to or more than 300° C., from which it is seen that these specimens show a sufficient heat insulating effect. In other words, it is seen that the surface treatment portions according to the embodiment of the present invention exhibit a sufficient heat insulating effect.

Particularly, in the specimens of Examples 2-3 to 2-8, the peak temperature T1 upon first-time irradiation with laser is equal to or more than 300° C., and a higher heat insulating effect is observed. This is considered to be because the low-thermal-conductivity material is contained in a volume ratio of equal to or more than 50%, also in the first layer on the surface layer side.

Note that the specimen of Comparative Example 2-4 showed T1 of 510° C., and T3 of 650° C., both being very high temperatures. It is to be noted, however, that the zirconia layer formed by plasma spraying is poor in adhesion at the interface with the specimen base material. In addition, in the case where the heat insulating effect is too high, the temperature rise is excessively localized. For this reason, even if a zirconia coating is formed at the piston crown surface by plasma spraying, durability would be poor, and it would be impossible to obtain a favorable combustion state, so that it is difficult to put the zirconia coating to practical use.

On the other hand, in the cases where the surface treatment portions shown in Examples 2-1 to 2-8 are each applied to the piston crown surface, a heat shielding effect is provided with respect to the depth direction of the surface treatment portion, and moderate heat conduction can be obtained along the surface of the piston crown surface; therefore, a suitable temperature distribution can be obtained through uniform heating of a suitable range, and a sufficient combustion promoting effect can be obtained over a wide range.

### Example 3

A procedure for forming a piston crown surface with a surface treatment portion will be described. Following the flowchart shown in FIG. 5, casting of a piston was conducted, as described above as step S1, using an aluminum alloy (AC8A) as a base material of the piston. Next, the crude material of the piston was subjected to primary machining, as described above as step S2. Subsequently, a series of steps of filling with a material, friction stir welding, and drawing-out of a rotary tool, as described above as steps S3 to S5, were repeated twice, to form a surface treatment portion. Next, a heat treatment was conducted as step S6, after which machining into a finished shape was performed by secondary machining as step S7, to produce a predetermined piston. Note that a recess to be filled with a powder was formed by machining a hole shape measuring 30 mm in diameter and 5 mm in depth at the time of the primary machining.

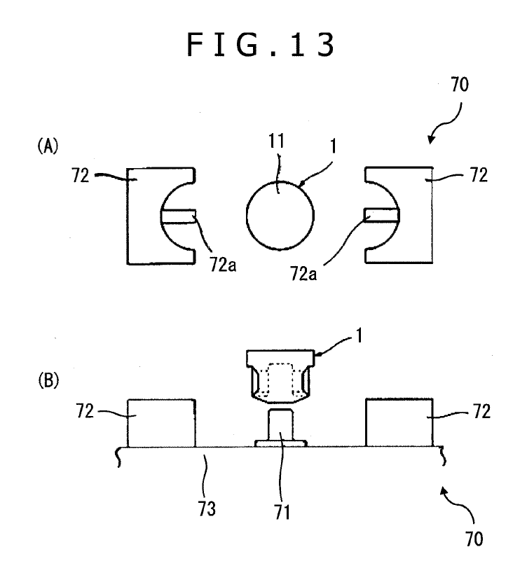

FIG. 13 shows views for explaining a layout relation between a joining jig 70 used at the time of forming a crude material of a piston with a surface treatment portion by friction stir welding and the piston. FIG. 13(A) is a plan view of a piston crown surface as viewed from above, and FIG. 13(B) is a side view of FIG. 13(A).

The joining jig 70 is configured by a base 73, a center jig 71 disposed on an upper surface of the base 73 for supporting a piston 1, and a pair of side jigs 72 movably mounted to the upper surface of the base 73 and fixing the piston 1 from lateral sides. A projection is formed on an upper surface of the center jig 71. In addition, a side surface, on the center jig 71 side, of each of the pair of side jigs 72 is formed as a cylindrical surface equal in radius to the side surface of the piston, and the cylindrical surface is formed with a projection 72a.

At the time of forming a crown surface of the piston 1 with a surface treatment portion by friction stir welding, the piston 1 is fixed as follows. First, a recess in a lower surface of the piston 1 is fitted to a projected portion of the center jig 71, whereby the piston 1 is held on the center jig 1. Next, the pair of side jigs 72 is moved toward the piston 1, the pair of projections 72a is inserted into holes in a side surface of the piston 1, and the side surface of the piston 1 is fixed by pressing from both sides by the cylindrical surfaces of the pair of side jigs 72. By this, the piston 1 is positioned and fixed in a position where a rotary tool is rotated at the time of friction stir welding.

### Example 4

A procedure for forming the surface treatment portion configured as shown in FIG. 4 will be described. The surface treatment portion shown in FIG. 4 has a configuration in which the third layer and the second layer in this order are formed alternately and repeatedly three times on a surface of a recess formed in the piston crown surface, and the first layer is provided thereon as an uppermost layer.

The piston 1 having a crown surface formed with the surface treatment portion configured in this way was produced following the flow chart shown in FIG. 5. First, a crude material of the piston 1 was cast. Next, the piston crude material was subjected to primary machining. A recess in the piston crown surface for forming the surface treatment portion was formed to have a diameter of 28 mm and a depth of 7.5 mm by the primary machining.

Subsequently, the recess was filled with a powder 51, after which a load was exerted while rotating a rotary tool having a diameter of 30 mm. By this, the powder 51 was pressed in by the rotary tool while crushing the periphery of the recess, to perform first-time friction stir welding, thereby forming the third layer and the second layer in this order. Next, a region over the second layer thus formed was filled with the powder 51, and a load was applied while rotating a rotary tool having a diameter of 32 mm. By this, on the third layer and the second layer previously formed, the third layer and the second layer were further formed in this order by second-time friction stir welding. Similarly, third-time friction stir welding was conducted using a rotary tool having a diameter of 34 mm, whereby the third layer and the second layer in this order were formed alternately and repeatedly three times. Subsequently, a region over the second layer situated at an uppermost portion was filled with a powder 52, and friction stir welding was similarly conducted while rotating a rotary tool having a diameter of 36 mm, whereby the first layer was formed as the uppermost layer. Thereafter, a heat treatment and secondary machining were carried out, to produce the piston 1.

By the above-mentioned steps, in the recess of the piston crown surface for forming the surface treatment portion, there was formed the surface treatment portion configured to have a total of seven layers, where the third layer and the second layer in this order were formed alternately and repeatedly three times and the first layer was formed thereon. The areas of the pluralities of third layers and second layers are so set that an upper layer is larger than a lower layer in diameter, and the first layer is the largest in area. By forming a layer having a thickness of 1 mm by one-time friction stir welding, the surface treatment portion having a thickness of 4 mm in total was formed by four times of friction stir welding. Note that while the diameter of the rotary tool is larger than the diameter of the recess in each run of the above-mentioned friction stir welding, the diameter of the recess and the diameter of the rotary tool may be equal.

The diameter of the rotary tool used for friction stir welding was 30 mm for the first-time friction stir welding, 32 mm for the second-time friction stir welding, 34 mm for the third-time friction stir welding, and 36 mm for the fourth-time friction stir welding. The powder 51 was used as the molding material for the first-time to third-time friction stir welding, and the powder 52 was used as the molding material for the fourth-time friction stir welding.

The layer formed by one-time friction stir welding was 1.0 mm, and the total thickness of the surface treatment portion as a whole was 4.0 mm. An oxygen-containing uppermost layer that was formed at an upper portion of the first layer formed by the fourth-time friction stir welding was cut away by the secondary machining.

By the above-described procedure, the piston 1 as shown in FIG. 4 was produced. This piston 1 has three third layers and three second layers, and the second layer as the uppermost layer, and the surface areas of the layers are so set that an upper layer is larger than a lower layer in surface area.

Note that it has been described above that in the case where a connection portion where the side surface and the bottom surface of the recess for forming the surface treatment portion is not a curved surface, the molding material is left at this portion in the state of not having undergone solid-phase adhesion, thereby causing generation of inadequate solid-phase joining. The reason of this is considered to lie in that heat is liable to be released at the connection portion, and a gap is generated between this portion and the rotary tool at the time of friction stir welding, so that a sufficient load is not easily exerted on the molding material at this portion.

For solving this problem, a method may be contemplated in which the projected portion of the center jig 71 and the recess in a piston lower portion are enhanced in dimensional accuracy, to thereby improve the fitting condition. However, the method in which the above-mentioned connection portion is made to be a curved surface is simpler than the just-mentioned solving method.

As has been described above, according to the present invention, it is possible to provide a piston for an internal combustion engine in which discharge of deposits and smoke is restrained and a favorable fuel cost is obtained owing to excellent heat insulating characteristic. In addition, it is possible to provide a piston for an internal combustion engine that is excellent in durability, since the surface treatment portion and the piston base material are firmly joined to each other.

Note that the present invention is not limited to the above-described embodiments. The specific constituent materials, parts and the like may be modified within such ranges as not to change the gist of the present invention. In addition, addition of known technologies or replacement with known technologies can be made, so long as the constituent elements of the present invention are included.

The disclosure of the following basic application for priority is incorporated herein by reference.

Japanese Patent Application No. 2015-233208 (filed on Nov. 30, 2015)

### DESCRIPTION OF REFERENCE CHARACTERS

1: Piston base material
2: Surface treatment portion
4: Rotary tool
11: Piston crown surface
21: Third layer
22: First layer
23: Second layer
31: Low-thermal-conductivity material
32: Metal
33: Metal containing oxygen or oxide of the metal
34: Metal
51, 52: Powder
61: Specimen
62: Vacuum chamber
63: Infrared camera
64: Laser light source
70: Joining jig
71: Center jig
72: Side jig
73: Base

1. A piston for an internal combustion engine, comprising a surface treatment portion on a piston base material at a piston crown surface, the surface treatment portion including, along a direction of depth from a surface side, a first layer that is comprised of a layer of a first metal or a layer containing the first metal, a second layer that contains both a second metal containing oxygen or an oxide of the second metal and a low-thermal-conductivity material, and a third layer that is comprised of a mixture of a third metal and the low-thermal-conductivity material.

2. The piston for an internal combustion engine as described in claim 1,
wherein the third metal is any one of aluminum, magnesium, iron, copper, zinc, titanium and nickel or an alloy containing at least one of these metals.

3. The piston for an internal combustion engine as described in claim 1,
wherein the first metal and the third metal are both aluminum or an aluminum alloy.

4. The piston for an internal combustion engine as described in claim 1,
wherein the first layer contains the low-thermal-conductivity material in addition to the first metal.

5. The piston for an internal combustion engine as described in claim 1,
wherein the second layer is thicker at a peripheral portion thereof than at a central portion thereof.

6. The piston for an internal combustion engine as described in claim 1,
wherein the second metal and the third metal are the same.

7. The piston for an internal combustion engine as described in claim 1,
wherein the first metal and the second metal are the same.

8. The piston for an internal combustion engine as described in claim 1,
wherein that portion of the third layer at which a surface opposite to a surface in contact with the second layer and an outer peripheral surface make contact with each other is composed of a curved surface.

9. The piston for an internal combustion engine as described in claim 1,
wherein a stirred portion of a material constituting the surface treatment portion and a material constituting the piston base material is provided between an outer peripheral portion of the surface treatment portion and the piston base material.

10. The piston for an internal combustion engine as described in claim 1,
comprising a plurality of the second layers.

11. The piston for an internal combustion engine as described in claim 1,
wherein the area of the third layer is smaller than the area of the first layer.

12. The piston for an internal combustion engine as described in claim 1,
wherein in the second layer and the third layer, the volume ratio of the low-thermal-conductivity material is equal to or more than 50%.

13. The piston for an internal combustion engine as described in claim 1,
wherein the low-thermal-conductivity material is a material containing at least one of zirconia, cordierite, mullite, silicon, silica, mica, talc, silicate glass, acrylic glass, organic glass, silica aerogel, hollow ceramic beads, hollow glass beads, hollow metal balls, organosilicon compound, ceramic fiber, titanium alloy, low alloy steel, and cast iron.

14. A method of manufacturing a piston for an internal combustion engine, the piston having a surface treatment portion at a crown surface,
wherein a step of forming the surface treatment portion comprises, at least:
a recess forming step of forming a recess in the crown surface of a piston base material of the piston;
a first filling step of filling the recess with a first molding material which is a powder or a green compact of a powder;
a first stir joining step of bringing a rotary tool into contact with the first molding material to soften the first molding material by frictional heat, thereby achieving solid-phase joining of the first molding material to the recess, and forming a stirred portion of the first molding material and the piston base material;
a second filling step of filling a region over a formed layer formed by solid phase joining in the first stir joining step with a second molding material which is a powder or a green compact of a powder; and
a second stir joining step of bringing a rotary tool into contact with the second molding material to soften the second molding material by frictional heat, thereby achieving solid-phase joining of the second molding material to the recess, and forming a stirred portion of the second molding material and the piston base material.
